(19) United States
(12) Patent Application Publication
(10) Pub. No.: US 2025/0316745 A1
(43) Pub. Date: Oct. 9, 2025

(54) SECONDARY BATTERY

(71) Applicant: Samsung SDI Co., Ltd., Yongin-si (KR)

(72) Inventors: Bo Hyun KIM, Yongin-si (KR); Heon Hee KIM, Yongin-si (KR); Seung Yeol YOO, Yongin-si (KR); Hyeok Joo KIM, Yongin-si (KR); Duck Hyun KIM, Yongin-si (KR); Woon Suk JANG, Yongin-si (KR)

(21) Appl. No.: 18/913,746

(22) Filed: Oct. 11, 2024

(30) Foreign Application Priority Data
Apr. 3, 2024 (KR) 10-2024-0045190

(51) Int. Cl. H01M 10/04; H01M 50/46; H01M 50/466

(52) U.S. Cl. CPC H01M 10/0459; H01M 50/46; H01M 50/466

(57) ABSTRACT

A secondary battery including: an electrode assembly including first and second electrode plates alternately stacked with a separator interposed therebetween and being folded in a state of being in contact with ends of the first electrode plate and the second electrode plate; and a case accommodating the electrode assembly.

### CROSS-REFERENCE TO RELATED APPLICATION

The present application claims priority to and the benefit of Korean Patent Application No. 10-2024-0045190, filed on Apr. 3, 2024, in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

Different from a primary battery that is not designed be (re)charged, a secondary battery is a battery that is designed to be charged and discharged. Low-capacity secondary batteries are widely employed in portable, small-sized electronic devices, such as smart phones, feature phones, notebook computers, digital cameras, or camcorders while large-capacity secondary batteries are widely used as power sources for driving motors of hybrid vehicles or electric vehicles. A secondary battery generally includes an electrode assembly having positive and negative electrodes, a case accommodating the electrode assembly, electrode terminals connected to the electrode assembly, and so on.

The above information disclosed in this Background section is for enhancement of understanding of the background of the present disclosure, and therefore, it may contain information that does not constitute prior art.

### SUMMARY

Embodiments of the present disclosure provide a secondary battery that can reduce the mobility of an electrode plate in an electrode assembly.

Embodiments of the present disclosure provide a secondary battery that can reduce the length of a separator in an electrode assembly.

However, aspects and features of the present disclosure are not limited to those mentioned above, and other aspects and features not mentioned herein will be clearly understood from the following description by those skilled in the art to which the disclosure belongs.

A secondary battery, according to an embodiment of the present disclosure, includes: an electrode assembly including first and second electrode plates alternately stacked with a separator interposed therebetween and being folded in a state of being in contact with ends of the first electrode plate and the second electrode plate; and a case accommodating the electrode assembly.

The separator may be bent in a Z shape and may include a plurality of bent areas in contact with one end of the first electrode plate and another end of the second electrode plate.

A number of first electrode plates may be greater than a number of second electrode plates.

The first electrode plate may be a negative electrode plate, and the second electrode plate may be a positive electrode plate.

A length of the first electrode plate in a width direction of the first electrode plate is L1, a length of the second electrode plate in a width direction of the second electrode plate is L2, and L1 may be greater than L2.

A center of the first electrode plate in the width direction of the first electrode plate and a center of the second electrode plate in the width direction of the second electrode plate may be located on the same straight line.

A first end is at one end of the first electrode plate in the width direction of the first electrode plate, a second end is at another end of the first electrode plate in the width direction of the first electrode plate, a third end is at one end of the second electrode plate in the width direction of the second electrode plate, a fourth end is at another end of the second electrode plate in the width direction of the second electrode plate, and the separator may in contact with the first end and the fourth end.

The electrode assembly may further include a fixing (or fixed) part that covers (or surrounds) an end of the first electrode plate that is not in contact with the separator and may be fixed to an outer surface of the separator.

The fixing part may include a fixed body in contact with the second end and a wing member extending from the fixed body and is fixed to the outer surface of the separator.

A secondary battery according to another embodiment of the present disclosure for includes: an electrode assembly including a separator bent in a zigzag shape and first and second electrode plates alternately stacked with the separator interposed therebetween; and a case accommodating the electrode assembly.

A number of first electrode plates and a number of second electrode plates may be different, and the folded position of the separator may coincide with one end of the first electrode plate in a width direction of the first electrode plate and another end of the second electrode plate in a width direction of the second electrode plate.

The electrode assembly may be wound in a roll form or may be installed in a vertically stacked form.

The case may be one of a pouch, a cylindrical can, or a square case.

A first end is at one end of the first electrode plate in a width direction of the first electrode plate, a second end is at another end of the first electrode plate in the width direction of the first electrode plate, a third end is at one end of the second electrode plate in a width direction of the second electrode plate, a fourth end is at another end of the second electrode plate in the width direction of the second electrode plate, and the first end and fourth end may be in contact with the separator.

The second end and third end may not be in contact with the separator.

The electrode assembly may further include a fixing (or fixed) part that covers (or surrounds) the second end and is fixed to an outer surface of the separator.

The fixing part may include a fixed body in contact with the second end and a wing member extending from the fixed body and fixed to the outer surface of the separator.

The fixing body may be spaced apart from the fourth end and from the separator covering (or surrounding) an outside of the fourth end.

According to embodiments of the present disclosure, movement of first and second electrode plates due to an external force can be prevented, thereby improving the safety of a secondary battery.

In addition, because a separator is installed in a state of being in contact with

ends of the first and second electrode plates, the material cost of the separator can be reduced.

However, aspects and features of the present disclosure are not limited to those mentioned above, and other aspects and features not mentioned herein will be clearly understood from the following description by those skilled in the art to which the disclosure belongs.

### BRIEF DESCRIPTION OF DRAWINGS

The following drawings attached to this specification illustrate embodiments of the present disclosure and provide a further understanding of the aspects and features of the present disclosure together with the detailed description of the present disclosure, and thus, the present disclosure should not be construed as being limited to the matters described in such drawings.

FIG. 1 is a perspective view of a secondary battery according to an embodiment of the present disclosure.

FIG. 2 is an exploded perspective view of an electrode assembly according to an embodiment of the present disclosure.

FIG. 3 is a front view of the electrode assembly according to an embodiment of the present disclosure.

FIG. 4 is a front view of the electrode assembly shown in FIG. 3 in which a fixed part is separated from the electrode assembly.

FIG. 5 is a front view of a separator of the electrode assembly shown in FIG. 3 according to an embodiment of the present disclosure.

FIG. 6 is a front view of a first electrode plate and a second electrode plate of the electrode assembly shown in FIG. 3 according to an embodiment of the present disclosure.

### DETAILED DESCRIPTION

Hereinafter, embodiments of the present disclosure will be described, in detail, with reference to the accompanying drawings. It should be noted that the terms and words used in the specification and the claims should not be construed as being limited to their ordinary meanings or dictionary definitions but should be construed in a sense and concept consistent with the technical concept of the present disclosure on the basis that the inventor can properly define the concept of a term to describe the disclosure in the best way possible. Therefore, embodiments described in the specification and the configurations illustrated in the drawings are only some embodiments of the present disclosure and do not represent all of the technical concepts of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

A reference to two objects in comparison being the same means that they are substantially the same. Further, the term “substantially the same” may include cases where the same is considered to be a low level in the related art, for example, a deviation within about 5%. In addition, when any of parameters is referred to as being uniform in a given region, it may mean that the parameter is uniform from an average perspective.

The terminology used herein is for the purpose of describing embodiments of the present disclosure and is not intended to be limiting of the present disclosure.

A secondary battery 1 according to an embodiment of the present disclosure will be described with reference to the drawings.

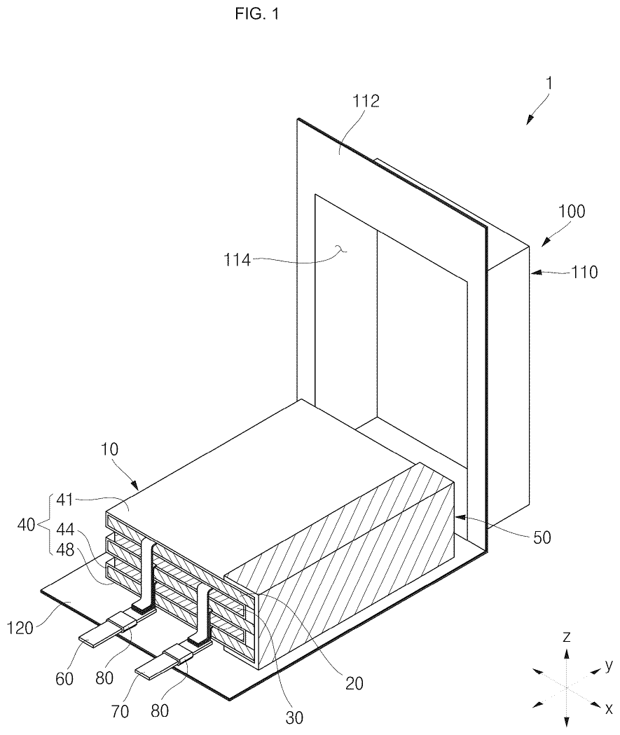

FIG. 1 is a perspective view of a secondary battery 1 according to an embodiment of the present disclosure. As shown in FIG. 1, the secondary battery 1 according to an embodiment of the present disclosure may include an electrode assembly 10 and a pouch 100, which acts as a case. The secondary battery 1 may further include a negative electrode lead 60, a positive electrode lead 70, and a tab film 80.

The electrode assembly 10 according to an embodiment of the present disclosure may include a first electrode plate 20, a second electrode plate 30, and a separator 40, which will be described in more detail later. The electrode assembly 10 may have a stack structure in which the separator 40 is folded into a Z shape. When the electrode assembly 10 is a Z-stack electrode assembly, during manufacture, transportation, etc., there may be a risk of movement occurring causing the relative position between the electrode plate(s) and the separator 40 to change. Therefore, according to embodiments of the present disclosure, the risk of movement of the first electrode plate 20 and the second electrode plate 30 can be reduced by bringing crossed ends of the first electrode plate 20 and the second electrode plate 30 into close contact with the separator 40.

In addition, according to embodiments of the present disclosure, in finishing the electrode assembly 10, tape may be wrapped on the end of the electrode assembly 10 to reduce the mobility of the first electrode plate 20 and the second electrode plate 30. Therefore, it is possible to prevent the separator 40, which is not supported by the first electrode plate 20 or the second electrode plate 30, from being bent due to movement of the first electrode plate 20 or the second electrode plate 30 inside the electrode assembly 10.

The case may be modified in various ways within the technical concept of accommodating the electrode assembly 10. For example, the case may be one of a pouch 100 (as in the illustrated embodiment), a cylindrical can, or a square case. The case, according to one embodiment of the present disclosure, is explained by using the pouch 100 as an example.

The pouch 100 has a space formed therein and may be modified into various shapes within the technical concept of surrounding the electrode assembly 10. The pouch 100 may be made of a soft (or flexible) film. The pouch 100 may be formed by folding a rectangular film extending in the longitudinal direction (e.g., the y direction), which is a second direction, to form a case body 110 and a case cover 120.

After the electrode assembly 10 is accommodated in a recess 114 provided in the case body 110, the case cover 120 rotatably connected to the case body 110 is rotated to be coupled to and sealed with the case body 110 in a state of being in contact therewith.

In another embodiment, the case body 110 and the case cover 120 may be formed as separate members. In other words, in the present disclosure, the pouch 100 is not limited to an integrated form in which the case body 110 and the case cover 120 are formed on a single film. However, for convenience of explanation, hereinafter, an embodiment in which the case body 110 and the case cover 120 are formed from a single rectangular film will be given as an example.

As used in the present disclosure, the first direction (or the width direction) is set to the x-axis direction, the second direction (or the longitudinal direction) is set to the y-axis direction, and the third direction (or the vertical direction) is set to the z-axis direction.

The case body 110 may include the recess 114 and a sealing part 112. The case body 110 may have the recess 114 in which the electrode assembly 10 is to be accommodated at approximately the center and may include the sealing part 112 extending approximately outwardly from three sides of the recess 114. In some embodiments, the sealing part 112 may extend outward from four sides of the recess 114.

The sealing part 112 may be a surface parallel to and coupled to the case cover 120. The case cover 120 and the case body 110 may be made of a multilayer thin film including (or consisting of) a metal thin film and an insulating layer formed on one side and the other side of the metal thin film, respectively. A side where the case cover 120 and the case body 110 are in contact with each other may be defined as an inner side, and the other side may be defined as an outer side.

The recess 114 in the case body 110 is formed to have a size sufficient to accommodate the electrode assembly 10 through pressing or drawing. The case body 110 may cover a portion where the recess 114 is formed by the case cover 120, and then, the edge of the recess 114 and the edge of the case cover 120 may be heat-fused with each other. After the electrode assembly 10 is accommodated in the recess 114, the pouch 100 may be sealed by sealing an edge area of the case body 110 and an edge area of the case cover 120.

For convenience, the edge of the case body 110 located outside of the recess 114 and sealed with the edge of the case cover 120 is defined as the sealing part 112. A heat fusion layer made of a heat fusible material may be formed on the inner surface of the pouch 100.

The case cover 120 may have a rectangular flat shape. The case cover 120 may be connected to the case body 110 through a folding portion. The case cover 120 may cover the upper part of the case body 110.

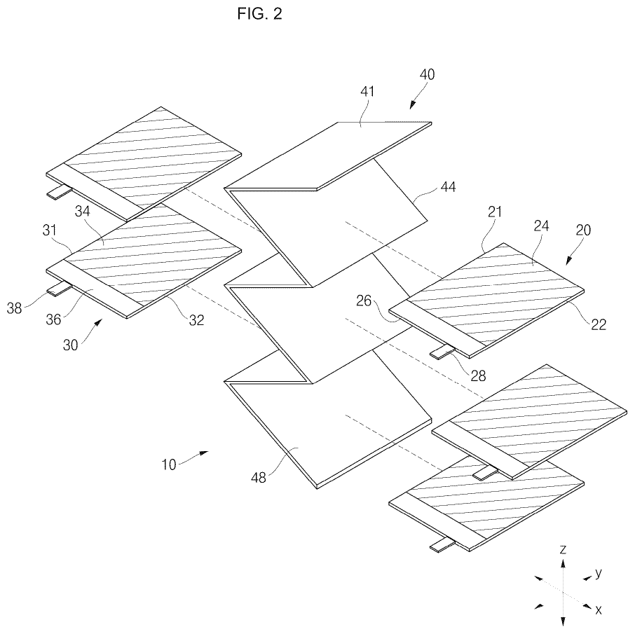

Referring to FIG. 2, the first electrode plate 20 includes a first electrode tab 28 electrically connected to a first uncoated portion 26, and the second electrode plate 30 includes a second electrode tab 38 electrically connected to a second uncoated portion 36. Thus, two electrode tabs (28 and 38) are provided. The first electrode tab 28 may be a substrate tab formed by stamping the first uncoated portion 26.

Stamping refers to a processing method for stamping metal plates or other materials into specific shapes. The first electrode tab 28 may be formed directly from the first uncoated portion 26 of the first electrode plate 20 through stamping. For example, the first electrode tab 28 may be formed by processing a portion of the first uncoated portion 26 instead of being added as a separate part. When the first electrode tab 28 is formed through stamping, electrical connection between the first electrode tab 28 and the first electrode plate 20 is strengthened and the manufacturing process can be simplified.

The second electrode tab 38 may be a substrate tab formed by stamping the second uncoated portion 36. As to a method of forming the second electrode tab 38 through stamping, the method of forming the first electrode tab 28 may be referred to.

The first electrode tab 28 and the second electrode tab 38 are welded to the first electrode lead 60 and the second electrode lead 70 of the external terminal, respectively, to be electrically connected to the outside. The tab film 80 for insulation from the pouch 100 is attached to the first electrode lead 60 and the second electrode lead 70. The first electrode lead 60 may be made of copper or nickel, and the second electrode lead 70 may be made of aluminum.

The pouch 100 is sealed by the sealing parts 112 at the edges in contact with each other in a state of accommodating the electrode assembly 10. The sealing may be performed in a state in which the tab film 80 is disposed between the sealing parts 112.

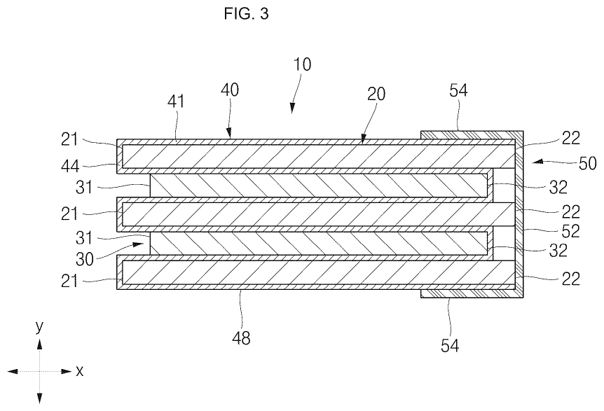

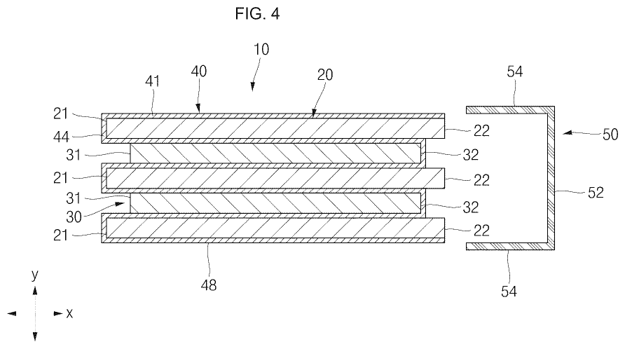

FIG. 2 is an exploded perspective view of an electrode assembly 10 according to an embodiment of the present disclosure, FIG. 3 is a front view of the electrode assembly 10 according to an embodiment of the present disclosure, and FIG. 4 is a front view thereof in which a fixed part 50 is separated from the electrode assembly 10 according to an embodiment of the present disclosure.

As shown in FIGS. 2 to 4, the electrode assembly 10 may include a first electrode plate 20, a second electrode plate 30, and a separator 40. Additionally, the electrode assembly 10 may be formed in a stacked form in which the first electrode plate 20, the separator 40, and the second electrode plate 30 are alternately stacked. The electrode assembly 10 stacked in a stacked manner can be implemented in various ways, such as being formed in a wound roll shape (also known as a jelly roll).

The electrode assembly 10 may be a Z-stack electrode assembly 10 in which the first electrode plate 20 and the second electrode plate 30 are inserted into both sides of the separator 40 and bent into a Z-stack. In addition, the electrode assembly 10 may be stored inside a case in which one or more electrode assemblies 10 are stacked so that their long sides are adjacent to each other, and the number of electrode assemblies 10 is not limited in the present disclosure. The first electrode plate 20 of the electrode assembly 10 may act as a negative electrode, and the second electrode plate 30 may act as a positive electrode. Of course, the opposite is also possible.

The electrode assembly 10 according to an embodiment of the present disclosure is accommodated in a pouch 100 and includes a first electrode plate 20, which is a negative electrode plate, a second electrode plate 30, which is a positive electrode plate, a separator 40 disposed between the first electrode plate 20 and the second electrode plate 30, and a tab formed in one direction. In the electrode assembly 10, the first electrode plate 20 and the second electrode plates 30 are alternately stacked with the separator 40 interposed therebetween. The electrode assembly 10 is stacked in a stack structure in which the separator 40 is folded into a Z shape.

The negative electrode plate, that is, the first electrode plate 20, may be (or may include) a plate made of copper (Cu) or nickel (Ni) having at least one surface thereof coated with a negative electrode active material, such as graphite or carbon, to form a first active material layer 24. In addition, the first uncoated portion 26 that is not coated with the negative electrode active material may be provided on one side of the negative electrode plate.

The first electrode tab 28 may act as a path for current flow between the first electrode plate 20 and the first electrode lead 60. In some embodiments, the first electrode tab 28 may be formed by cutting to protrude from one side in advance when manufacturing the first electrode plate 20 and may protrude further on one side than (e.g., may protrude beyond) the separator 40 without separate cutting.

A first end 21 may be located at one end in the width direction (e.g., the x direction) of the plate-shaped first electrode plate 20, and a second end 22 may be located at the other end in the width direction (e.g., the x direction) of the first electrode plate 20.

According to one embodiment of the present disclosure, the first electrode plate 20 and the second electrode plate 30 are formed in different numbers. In one embodiment, the number of first electrode plates 20 may be greater than the number of second electrode plates 30. The first electrode plate 20 may be located at the top of the electrode assembly 10, and the second electrode plate 30 and the first electrode plate 20 may be alternately stacked in that order below the first electrode plate 20. In addition, the first electrode plate 20 may be located at the bottom of the electrode assembly 10.

The second electrode plate 30 may have a second active material layer 34 formed by applying a second electrode active material, such as a transition metal oxide, to a second electrode current collector plate formed of a metal foil, such as aluminum (Al) or aluminum alloy. In addition, the second electrode plate 30 may have a second uncoated portion 36, which is an area to which the second electrode active material is not applied.

The second electrode tab 38 may act as a path for current flow between the second electrode plate 30 and the second electrode lead 70. In some embodiments, the second electrode tab 38 may be formed by cutting to protrude from one side in advance when manufacturing the second electrode plate 30 and may protrude further on one side than (e.g., may protrude beyond) the separator 40 without separate cutting.

A third end 31 may be located at one end in the width direction (e.g., the x direction) of the second electrode plate 30, and a fourth end 32 may be located at the other end in the width direction (e.g., the x direction) of the second electrode plate 30.

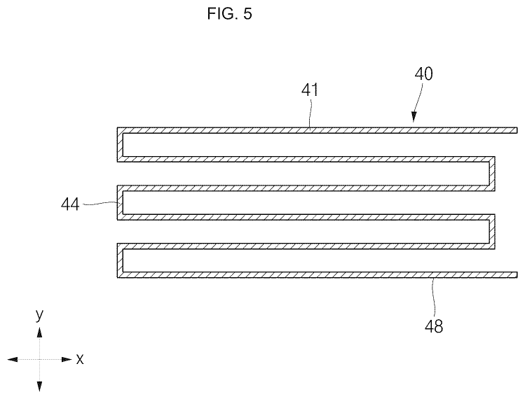

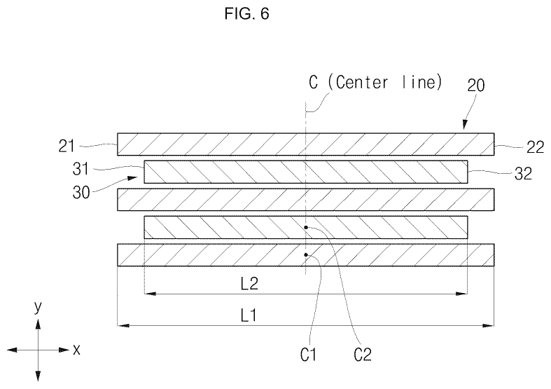

FIG. 5 is a front view of a separator 40 of the electrode assembly 10 according to an embodiment of the present disclosure, and FIG. 6 is a front view of a first electrode plate 20 and a second electrode plate 30 of the electrode assembly 10 according to an embodiment of the present disclosure. As shown in FIGS. 4 to 6, the separator 40 may be folded to be in contact with the ends of the first electrode plate 20 and the second electrode plate 30. The separator 40 is bent in a Z shape and may have a plurality of bent areas in contact with one end of the first electrode plate 20 and the other end of the second electrode plate 30.

The separator 40 may be formed of (or may include) polyethylene (PE) or polypropylene (PP) but is not limited thereto. The separator 40 prevents an electrical short between the positive electrode plate and the negative electrode plate and allows the movement of lithium ions therebetween.

The separator 40 is formed from (e.g., is made in the shape of) a single plate and may be bent and stacked in a Z shape to be interposed between the first electrode plate 20 and the second electrode plate 30. Of course, similar to the first electrode plate 20 and the second electrode plate 30, a plurality of separators 40 may be stacked between the first electrode plate 20 and the second electrode plate 30. In addition, the separator 40 may be formed to be larger in size than the first electrode plate 20 and the second electrode plate 30 to prevent short circuit between the first electrode plate 20 and the second electrode plate 30. In addition, the first electrode plate 20 may be arranged at the outermost edge of the electrode assembly 10, that is, at the top and bottom with respect to the electrode assembly 10 stacked in the vertical direction (e.g. the z direction).

The separator 40 may be bent in a zigzag shape, and the folded position of the separator 40 coincides with one end in the width direction (x) of the first electrode plate 20 and the other end in the width direction (x) of the second electrode plate 30. In an example, the separator 40 may be installed in a state of being in contact with the first end 21 and the fourth end 32. In addition, the second end 22 and the third end 31 may be installed not in contact with the separator 40.

When the first electrode plate 20 and the second electrode plate 30 are alternately stacked in the vertical direction (e.g., the z direction), the first electrode plate 20 may be stacked one more time than the second electrode plate 30. The first end 21 is located at the end of one side (e.g., the left side in FIG. 6) of the first electrode plate 20, and the third end 31 is located at the end of one side (e.g., the left side in FIG. 6) of the second electrode plate 30. In addition, the second end 22 is located at the other side (e.g., the right side in FIG. 6) of the second electrode plate 30, and the fourth end 32 is located at the other side (e.g., the right side in FIG. 6) of the second electrode plate 30.

The separator 40 is folded in a zigzag shape, and the first electrode plate 20 and the second electrode plate 30 are alternately inserted into the folded spaces of the separator 40. The separator 40 includes a first cover 41 that forms the upper side of the electrode assembly 10, a second cover 48 that forms the lower side of the electrode assembly 10, and a body part 44 that connects the first cover 41 and the second cover 48 and is folded in a zigzag shape. The first electrode plate 20 is located on the lower side of the first cover 41, and the second electrode plate 30 is located on the lower side of the first electrode plate 20 with the body part 44 of the separator 40 interposed therebetween.

When the length in the width direction (e.g., the x direction) of the first electrode plate 20 is L1 and the length in the width direction (e.g., the x direction) of the second electrode plate 30 is L2, L1 may be greater than L2. for example, the length L1 in the width direction of the first electrode plate 20 may be greater than the length L2 in the width direction of the second electrode plate 30.

In addition, the center C1 in the width direction of the first electrode plate 20 and the center C2 in the width direction of the second electrode plate 30 may be located on (or aligned along) the same straight line. For example, the reference line C in the vertical direction (e.g., the z direction) is a vertical line extending in the vertical direction, and the center C1 in the width direction of the first electrode plate 20 and the center C2 in the width direction of the second electrode plate 30 are located on the reference line C in the vertical direction.

In addition, the body part 44 of the separator 40 extending to the upper side of the second cover 48 is connected to the first cover 41 in a folded state while sequentially contacting the first end 21, the fourth end 32, the first end 21, the fourth end 32, and the first end 21. Because the first end 21 and the fourth end 32 are installed in a state of being in contact with the separator 40, movement of the first electrode plate 20 or the second electrode plate 30 due to external shock, etc. may be prevented or reduced.

However, because the separator 40 that supports the second end 22 of the first electrode plate 20 is not provided (e.g., because the separator 40 exposes or does not contact the second end 22 of the first electrode plate 20), the first electrode plate 20 may move in the horizontal direction. A fixed part (or fixing part) 50 may be additionally installed to prevent horizontal movement of the first electrode plate 20.

The electrode assembly 10 according to an embodiment of the present disclosure further includes the fixed part 50 that surrounds (or covers) the end of the first electrode plate 20 that is not in contact with the separator 40 and is fixed to the outside of the separator 40. The fixed part 50 may be modified in various ways within the technical concept of surrounding the second end 22 of the first electrode plate 20 and being fixed to the outside of the separator 40. In one embodiment, the fixed part 50 may include a fixed body 52 installed in a state of being in contact with the second end 22 and a wing member 54 extending from the fixed body 52 and fixed to the outside of the separator 40.

The fixed body 52 extends in the vertical direction (z) and can be installed in a shape that contacts the second end 22. The wing member 54 extends in the horizontal direction from the upper end of the fixed body 52 and is fixed to the upper side of the first cover 41. Another wing member 54 extends in the horizontal direction from the lower end of the fixed body 52 and is fixed to the lower side of the second cover 48. In addition, the fixed body 52 may be installed in a state of being spaced apart from the fourth end 32 and the separator 40 surrounding the outside of the fourth end 32.

Therefore, because the first end 21 of the first electrode plate 20 is in contact with the separator 40 and the second end 22 of the first electrode plate 20 is in contact with the fixed part 50, horizontal movement of the first electrode plate 20 is constrained. In addition, because the fourth end 32 of the second electrode plate 30 is in contact with the separator 40, horizontal movement of the second electrode plate 30 can be reduced.

The fixed part 50 may be made of a polymer material or as rubber band that does not conduct electricity. The polymer material or rubber band acts as an electrical insulator and can reduce or minimize the influence of the electrolyte. For example, the fixed part 50 may be manufactured from a polymer material, such as polypropylene, or an electrical insulating tape, such as a rubber band.

As described above, except for the third end 31, which is one end of the second electrode plate 30, the ends in the width direction of the first electrode plate 20 and the second electrode plate 30 are installed in a state of being in contact with the separator 40 or the fixed part 50, and thus, movement of first and second electrode plates 20 and 30 due to an external force can be prevented or reduced, thereby improving the safety of the secondary battery 1. In addition, because the separator 40 is installed in a state of being in contact with ends of the first and second electrode plates 20 and 30, the amount (e.g., the material amount or overall size) of the separator 40 can be reduced, thereby reducing material costs. In addition, because the folded position of the separator 40 coincides with one end in the width direction of the first electrode plate 20 and the other end in the width direction of the second electrode plate 30, distortion in the shape of the electrode assembly 10 during manufacture and use of the secondary battery 1 can be reduced.

While the secondary battery 1 has been described as one embodiment according to the present disclosure, it should be understood that the embodiment described herein should be considered in a descriptive sense and not for purposes of limitation. Various changes in form and details may be made to the described embodiment without departing from the spirit and scope of the present disclosure as defined by the following claims and their equivalents.

what is claimed is:

1. A secondary battery comprising:
an electrode assembly comprising first and second electrode plates that are alternately stacked with a separator interposed therebetween, the separator being folded in a state of being in contact with ends of the first electrode plate and the second electrode plate; and
a case accommodating the electrode assembly.

2. The secondary battery as claimed in claim 1, wherein the separator is bent in a Z shape and has a plurality of bent areas in contact with one end of the first electrode plate and another end of the second electrode plate.

3. The secondary battery as claimed in claim 1, wherein a number of first electrode plates is greater than a number of second electrode plates.

4. The secondary battery as claimed in claim 3, wherein the first electrode plate is a negative electrode plate, and the second electrode plate is a positive electrode plate.

5. The secondary battery as claimed in claim 3, wherein a length of the first electrode plate in a width direction is L1 and a length of the second electrode plate in the width direction is L2, and
wherein L1 is greater than L2.

6. The secondary battery as claimed in claim 5, wherein a center in the width direction of the first electrode plate and a center in the width direction of the second electrode plate are located on the same straight line.

7. The secondary battery as claimed in claim 1, wherein a first end of the first electrode plate is at one end in a width direction of the first electrode plate and a second end of the first electrode plate is at another end in the width direction of the first electrode plate,
wherein a third end of the second electrode plate is at one end in a width direction of the second electrode plate and a fourth end of the second electrode plate is at another end in the width direction of the second electrode plate, and
wherein the separator is in contact with the first end and the fourth end.

8. The secondary battery as claimed in claim 7, wherein a number of first electrode plates is greater than a number of second electrode plates.

9. The secondary battery as claimed in claim 8, wherein the electrode assembly further comprises a fixing part that covers the second end of the first electrode plate that is not in contact with the separator, and
wherein the fixing part is fixed to an outer surface of the separator.

10. The secondary battery as claimed in claim 9, wherein the fixing part comprises:
a fixed body in contact with the second end; and
a wing member extending from the fixed body and fixed to the outer surface of the separator.

11. A secondary battery comprising:
an electrode assembly comprising a separator bent in a zigzag shape and first and second electrode plates alternately stacked with the separator interposed therebetween; and
a case accommodating the electrode assembly,
wherein a number of first electrode plates and a number of second electrode plates are different, and
wherein the folded position of the separator coincides with one end of the first electrode plate in a width direction of the first electrode plate and another end of the second electrode plate in a width direction of the second electrode plate.

12. The secondary battery as claimed in claim 11, wherein the electrode assembly is wound in a roll form or is in a vertically stacked form.

13. The secondary battery as claimed in claim 11, wherein the case is one of a pouch, a cylindrical can, or a square case.

14. The secondary battery as claimed in claim 11, wherein a first end of the first electrode plate is at one end in the width direction of the first electrode plate and a second end of the first electrode plate is at another end in the width direction of the first electrode plate,
wherein a third end of the second electrode plate is at one end in the width direction of the second electrode plate and a fourth end of the second electrode plate is at another end in the width direction of the second electrode plate, and
wherein the first end and fourth end are installed in contact with the separator.

15. The secondary battery as claimed in claim 14, wherein the second end and third end are not in contact with the separator.

16. The secondary battery as claimed in claim 14, wherein the electrode assembly further comprises a fixing part that covers the second end and is fixed to an outer surface of the separator.

17. The secondary battery as claimed in claim 16, wherein the fixing part comprises a fixed body in contact with the second end and a wing that extending from the fixed body and fixed to the outer surface of the separator.

18. The secondary battery as claimed in claim 17, wherein the fixing body is spaced apart from the fourth end and from the separator covering an outside of the fourth end.

19. The secondary battery as claimed in claim 11, wherein the number of first electrode plates is greater than the number of second electrode plates.

20. The secondary battery as claimed in claim 11, wherein a length in the width direction of the first electrode plate is L1, and a length in the width direction of the second electrode plate is L2,
wherein L1 is greater than L2, and
wherein a center in the width direction of the first electrode plate and a center in the width direction of the second electrode plate are located on the same straight line.
